(19) United States
(12) Patent Application Publication
(10) Pub. No.: US 2013/0221729 A1
(43) Pub. Date: Aug. 29, 2013

(54) TRAY ASSEMBLY

(71) Applicant: Stephen John Irwin, Aberdeen (AU)

(72) Inventor: Stephen John Irwin, Aberdeen (AU)

(21) Appl. No.: 13/988,286

(22) PCT Filed: Nov. 17, 2011
(86) PCT No.: PCT/AU11/01490

§ 371 Date: May 17, 2013

(30) Foreign Application Priority Data
Nov. 18, 2010 (AU) 2010246405

(51) Int. Cl. B60P 1/28

(52) U.S. Cl. CPC B60P 1/283
USPC 298/19 R

(57) ABSTRACT

A tray assembly including a tray having a base, a pair of side walls spaced apart between a pair of end walls, the walls extending away from the base to define a space to receive material to be towed; the tray being supported by a frame, the frame having a pair of side rails spaced apart between a pair of end rails to form a generally rectangular shape, the frame includes a carriage to mount said frame to a structure. Each side rail having a series of spaced apart rollers adapted to engage corresponding guides located on said tray, respective rollers and guides are operatively associated with each other to assist movement of said tray with respect to said frame.

### FIELD OF THE INVENTION

The present invention relates to a tray assembly for a trailer, ute or the like.

### BACKGROUND OF THE INVENTION

A tray assembly is useful for transporting bulk material, such as garden waste, soil, mulch, and other such materials. The trailer typically includes a holding space which is defined by a base and four sidewalls extending from the base. The rear sidewall is typically configured as a tail gate which is hinged to the base panel and detachable from the other sidewalls such that the bulk material in the load space can exit therethrough when the trailer is tipped.

The trailer typically includes a tray which is supported in its horizontal position by a support frame. The support frame includes a load bar for attaching the trailer to a towing vehicle and wheels for supporting the trailer along the ground. The tray is pivotally attached to the support frame such that when tipped, the load in the tray can be unloaded therefrom.

The pivot axis of the tray relative to the support frame is generally parallel to the axle of the wheels. This allows the tray to be pivoted in a rearward direction to unload the tray.

As a loaded tray is generally heavy, the trailer includes an electric or a manual winch or hydraulic ram for moving the tray from its horizontal position to its tilted tipping position.

The difficulty with the existing trailers is that they can be quite expensive as the addition of a winch or hydraulic ram adds to the cost thereof and also adds to the maintenance cost of the trailer.

### OBJECT OF THE INVENTION

It is the object of the present invention to substantially overcome or at least ameliorate one or more of the prior art disadvantages or at least provide a useful alternative.

### SUMMARY OF THE INVENTION

There is disclosed herein a tray assembly including:

a tray having a base, a pair of side walls spaced apart between a pair of end walls, the walls extending away from the base to define a space to receive material to be moved;

the tray being supported by a frame, the frame having a pair of side rails spaced apart between a pair of end rails to form a generally rectangular frame, including a carriage to mount said frame to a structure;

each side rail having a series of spaced apart rollers adapted to engage a corresponding guide located on said tray, respective rollers and guides operatively associated with each other to assist movement of said tray with respect to said frame;

the frame further including a stop member;

a catch member on said tray adapted in use to engage said stop member, engagement of said catch and stop members forming a pivot point of said tray;

whereby when said catch member engages said stop member said tray tips about said pivot point assisting removal of said material from said space through an opening located adjacent a tailgate of said tray assembly.

Preferably, said catch member includes an adjustment means.

Preferably, said adjustment means includes a plate having at least two holes and a pin, said pin being moveable between said holes to adjust said pivot point of said tray as said pin contacts said stop member.

Preferably, the structure includes an axle supporting at least a pair of wheels, the stop member being located substantially perpendicular to said wheels.

Preferably, wherein the tray includes a bottom panel located between said end walls.

Preferably, said plate includes a plurality of spaced apart holes.

Preferably, including level adjustment means located at an end of said tray assembly remote said tailgate, said level adjustment means adapted in use to raise or lower said end relative to a surface upon which said tray assembly rests.

### BRIEF DESCRIPTION OF THE DRAWINGS

A preferred embodiment of the present invention will now be described, by way of example only, with reference to the accompanying drawings wherein:

FIG. 1 is a side view of a trailer according to a preferred embodiment of the present invention shown in its horizontal loading position;

FIG. 2 is a side view of the trailer of FIG. 1 in a partially tipped position;

FIG. 3 is a side view of the trailer of FIG. 1 in a fully tipped position;

FIG. 4 is a front view of the trailer of FIG. 1 in a fully tipped position;

FIG. 5 is an enlarged left hand side view of the trailer of FIG. 1 showing the trailer's stop member;

FIG. 6 shows the trailer in a tipped position;

FIG. 7 is an enlarged view of the trailer in the tipped position;

FIG. 8 is an enlarged view of the trailer;

FIG. 9 shows an enlarged view of the trailer;

FIG. 10 shows an enlarged view of the trailer;

FIG. 11 shows an enlarged view of the trailer;

FIG. 12 shows an enlarged view of the trailer;

FIG. 13 shows the load bar and attachment; and

FIG. 14 shows a stop for the pivot of the tray.

### DETAILED DESCRIPTION OF THE INVENTION

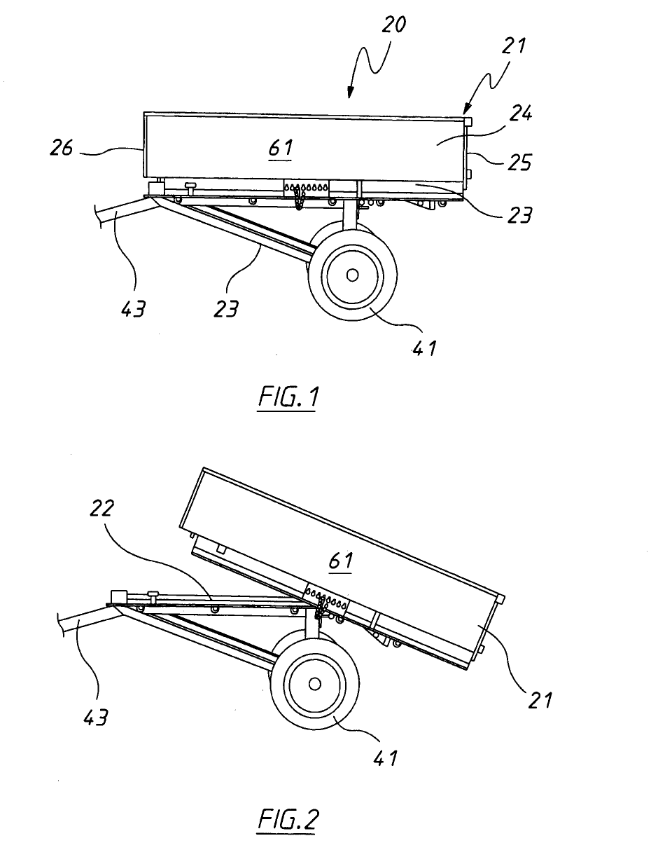

FIGS. 1 to 14 show a tray assembly 20 in the form of a trailer according to a. preferred embodiment of the present invention. The tray assembly 20 includes a tray 21 supported by a towable support frame 22. The support frame 22 includes parallel side rails 30 and 32 connected at their front and rear ends by end rails 34, 36 to form a generally rectangular configuration.

The support frame 22 includes a carriage 23 having vertical members 38 extending from the rear rail 36 and diagonal members 42 extending from the front rail 34 to an axle support 39 which has an axle (not shown) therein for supporting wheels 41. The frame 22 also includes a mid-portion support member 37 extending between the front and rear rails 34 and 36. The frame 22 also includes a load bar 43 extending away from the front rail 34. The load bar 43 is for attachment of the trailer 20 to a towing vehicle (not shown).

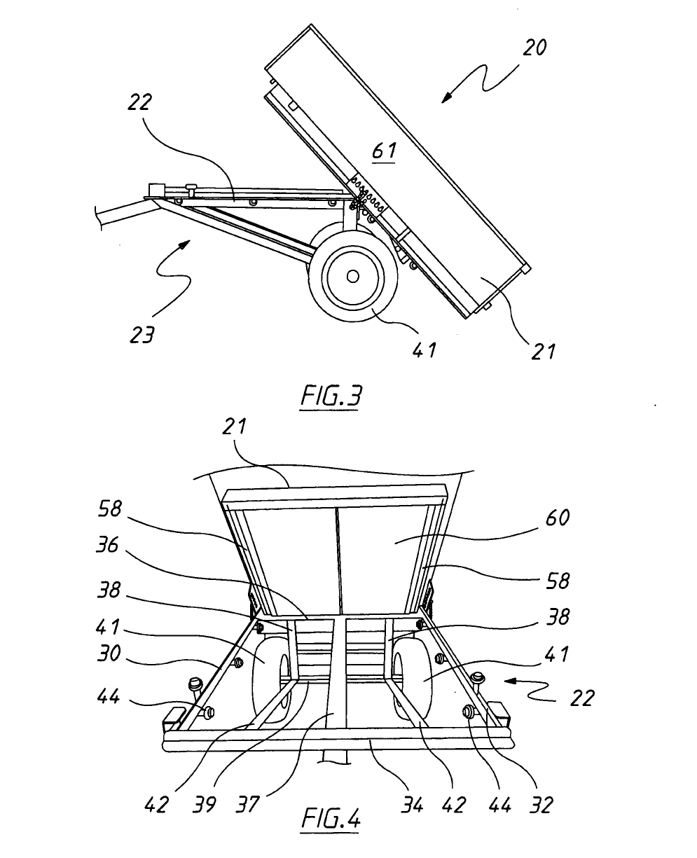

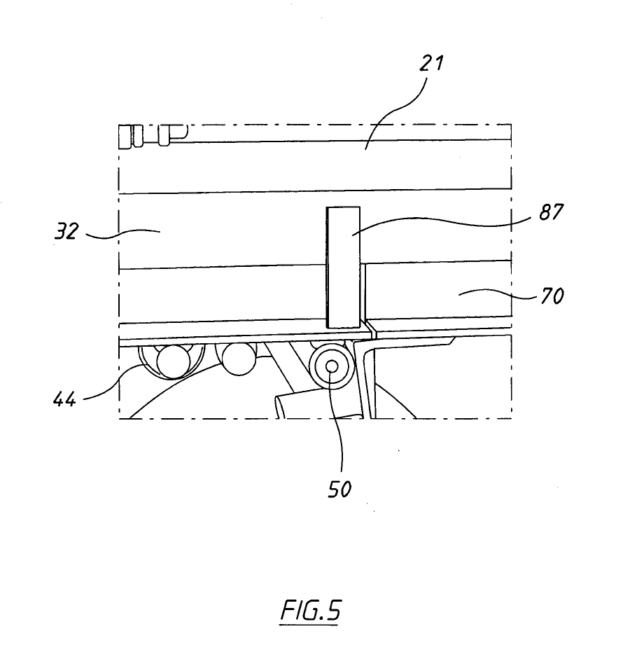

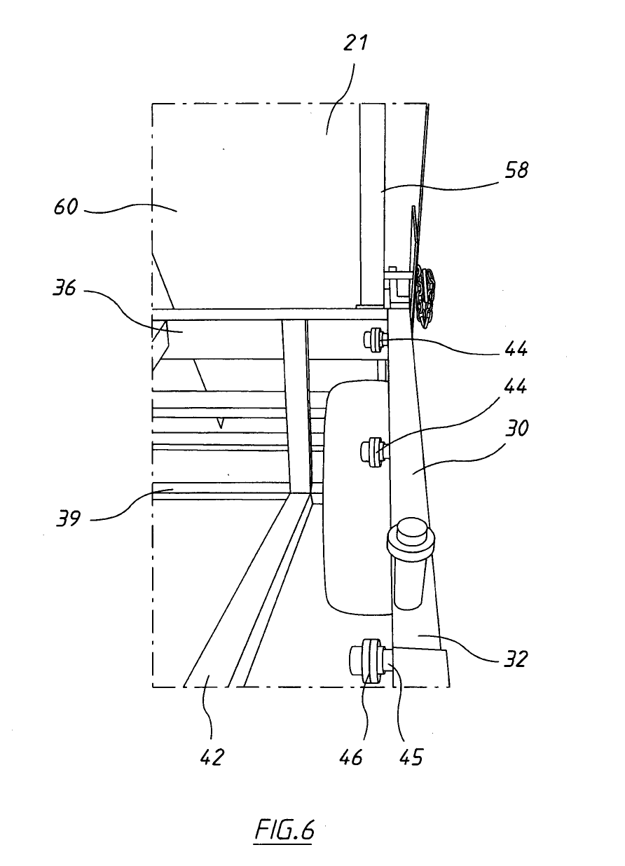

As shown in FIGS. 4 and 6, the side rails 30 and 32 each include a plurality of spaced rollers 44, which in one embodiment includes a rod 45 attached to the rail 30 or 32 and a roller bearing 46 mounted onto the rod 45. The axis of rotation of the rollers 46 are thus parallel to the rear rail 36.

FIGS. 5 to 12 show a rear section 70 which in one embodiment can be attached to the frame 22. The rear section 70 of the frame 22 includes an extension of the side rails 30 and 32. The rear section 70 is pivotally attached to the front section of the frame 22 (as best seen in FIG. 10) such that it can pivot towards the wheels 41 and ground surface. The rear section 70 includes a pivot bar 50. The rear section 70 of the support frame 22 can rotate relatively to the front section from its horizontal position to its tilted angle position where the rear section 70 is adjacent the wheels 41.

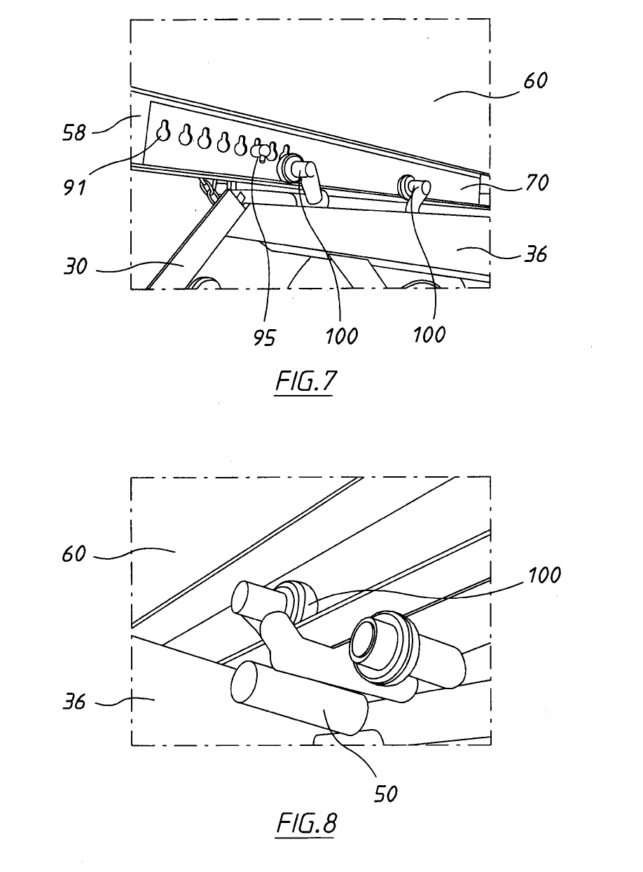

The tray 21 includes a bottom panel 60, side walls 61, a rear wall and a front wall (not shown). The rear wall can include a tailgate (not shown) which is in a typical form. The bottom tray, side walls, front wall and rear wall together form the loading space (not shown) of the tray 21. Side plates or guides 58 extend from the bottom of the bottom panel 60 of the tray 21, each side plate 58 comprising a vertical web and a horizontal web extending therefrom as best seen in FIG. 4. In an embodiment the horizontal web extends towards the middle portion of the trailer 20. The tray 21 is supported by the support frame 22 via the side plates engaging the rollers 44 of the frame 21. As shown in FIGS. 7 and 8, the rollers 100 of the rear section 70 are arranged to engage the guides 58. This allows the tray 21 to be movable relative to the support frame 22 in the longitudinal direction generally parallel to the ground surface.

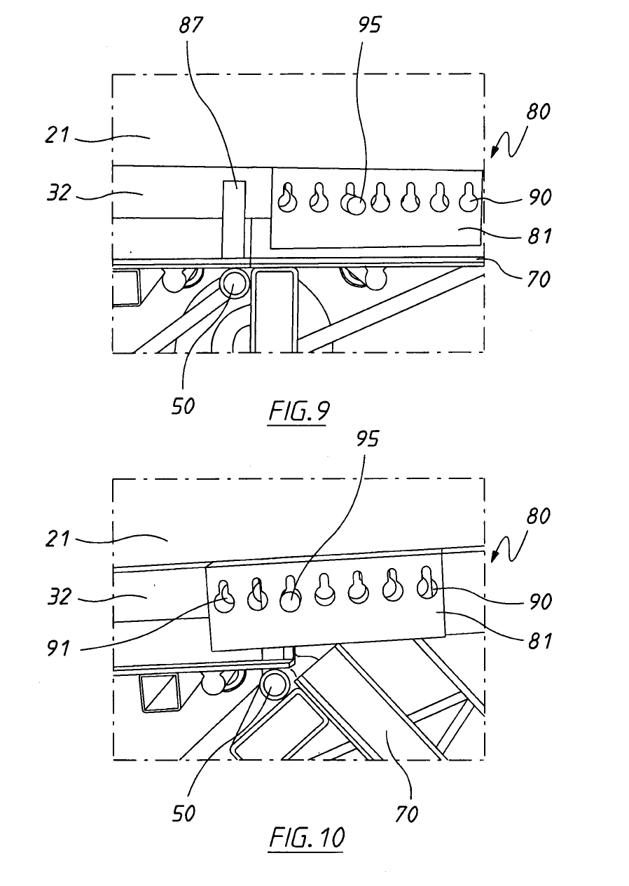

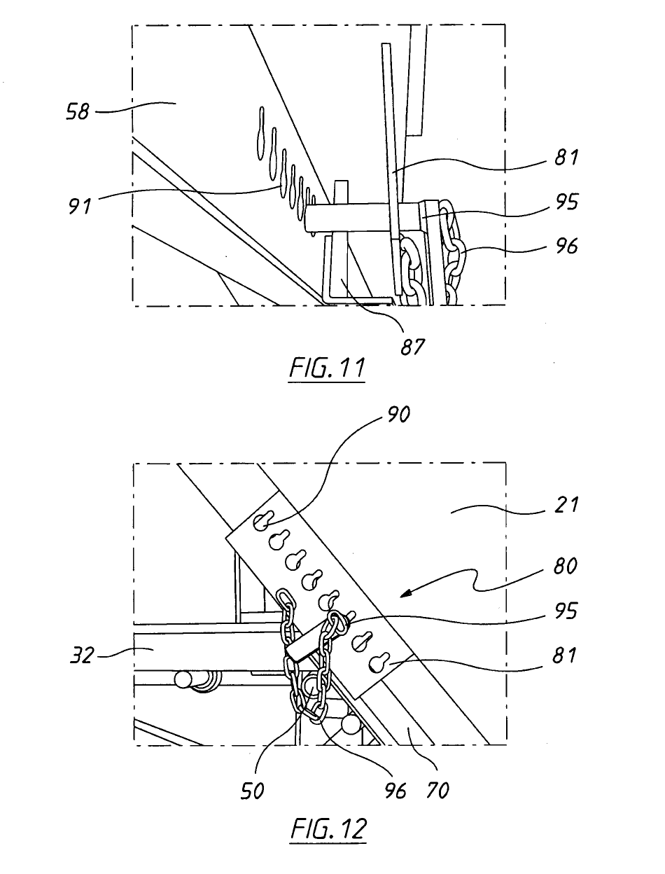

The tray 21 further includes a pivot point selection assembly or adjacent means 80 (best seen in FIGS. 9 to 12) at each side thereof. The selection assembly 80 includes a plate 81 attached to the bottom 60 of the tray 21 and parallel to the guide rails 58. The plate 81 includes a number of spaced key holes or apertures 90 and the guide rail 58 includes a corresponding number of spaced key holes or apertures. A rod or pin 95 can be inserted through aligned holes 90, 91 and retained in place via a chain or the like 96. The adjacent means 80 in use pivots the tray when the pin 95 contacts the stop member 87 located on the frame 22 as best seen in FIG. 11.

In use, once the vehicle is in a stopped position the tail gate of the tray assembly 20 is opened and locked in position by any typical locking means. For example, a pin and hole assembly. The tray 21 is then slid rearwardly relative to the support frame 22. When the pin engages the stop member 87, movement of the tray 21 relative to the frame 22 is stopped. At this point, the centre of gravity of the tray 21 will be located to the rear of the pivot point. This will essentially allow the tray 21 to tip in the rearward direction either by itself or assisted manually by an operator. As the tailgate of the trailer 20 is already open the tray 21 can be unloaded.

When unloading is finished, the front portion of the tray 21 can be engaged to return the tray 21 to its horizontal position and the tray 21 is then moved forward which moves the centre of gravity of the tray 21 towards the front of the pivot point. The tailgate can be locked closed. The tray assembly 20 can include a locking means for retaining the tray 21 in its forward and horizontal position to prevent same from moving backwards.

It can thus be seen that the pivot point at which the pin 95 (catch member) engages the stop member 87 can be selected which allows the user to select the desired position of the centre of gravity of the tray 21 prior to moving the tray 21 to a tipped position. Thus, the present invention provides a tray 21 which allows the user to unload the tray 21 manually with ease and which does not require a lot of effort.

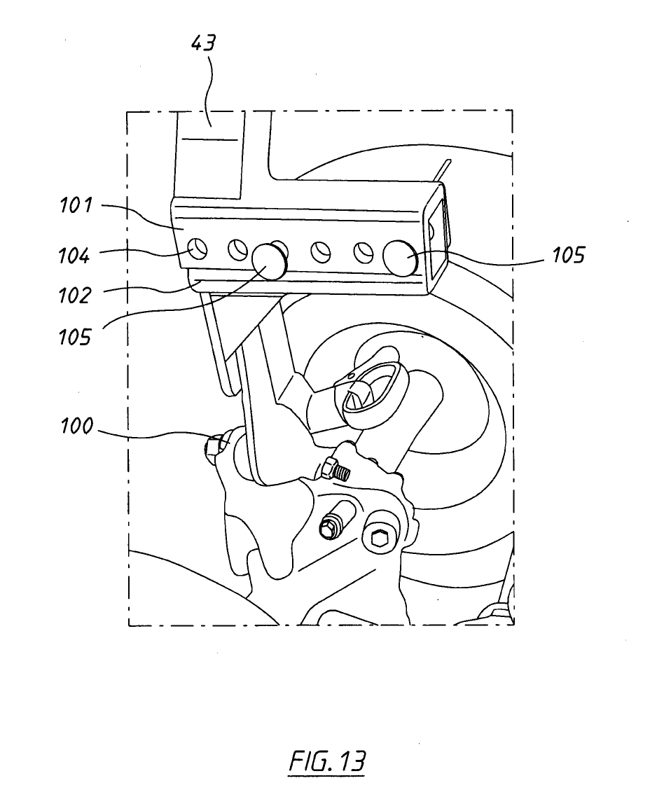

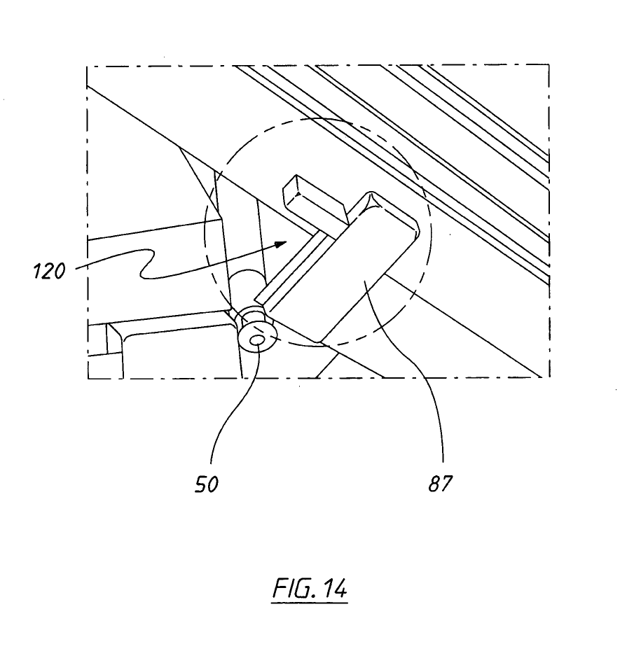

As shown in FIG. 13, the load bar 43 can include adjustment means to adjust the trailer to above a level position when connected to a tow bar 100. This allows many different vehicles to use the same trailer 20. The trailer 20 should be located slightly above level for the trailer to tip by itself. The adjustment means includes a first member 101 engageable with a second member 102. Each member 101, 102 having complimentary holes 104 and one or more pins 105 to lock the members 101, 102 together and adjust the height of an end of the load bar 43 from the surface upon which the trailer rests.

In an alternate embodiment, the tray assembly 20 including the tray 21 and frame 22 (including carriage 23) are locatable on an existing structure. This structure could be fixed or moveable, for example on the back of a truck, ute, bogie, trailer or the like. In further embodiments (for example as shown in FIG. 14) the adjustable pin 95 can be replaced by a pin locatable in a fixed location or a second stop 120 utilised to contact the stop member 87 preferably positioned on the rear section 70 to help with the tipping of the tray 21.

Although a preferred embodiment of the present invention has been described, it will be apparent to a skilled person that modifications to the embodiment described can be made or that the invention can be embodied in other forms.

1. A tray assembly including:
a tray having a base, a pair of side walls spaced apart between a pair of end walls, the walls extending away from the base to define a space to receive material to be moved;
the tray being supported by a frame, the frame having a pair of side rails spaced apart between a pair of end rails to form a generally rectangular frame, including a carriage to mount said frame to a structure;
each side rail having a series of spaced apart rollers adapted to engage a corresponding guide located on said tray, respective rollers and guides operatively associated with each other to assist movement of said tray with respect to said frame;
the frame further including a stop member;
a catch member on said tray adapted in use to engage said stop member, engagement of said catch and stop members forming a pivot point of said tray;
whereby when said catch member engages said stop member said tray tips about said pivot point assisting removal of said material from said space through an opening located adjacent a tailgate of said tray assembly.

2. The tray assembly of claim 1, wherein said catch member includes an adjustment means.

3. The tray assembly of claim 2, wherein said adjustment means includes a plate having at least two holes and a pin, said pin being moveable between said holes to adjust said pivot point of said tray as said pin contacts said stop member.

4. The tray assembly of claim 1, wherein the structure includes an axle supporting at least a pair of wheels, the stop member being located substantially perpendicular to said wheels.

5. The tray assembly of claim 1, wherein the tray includes a bottom panel located between said end walls.

6. The tray assembly of claim 3, wherein said plate includes a plurality of spaced apart holes.

7. The tray assembly of claim 1, including level adjustment means located at an end of said tray assembly remote said tailgate, said level adjustment means adapted in use to raise or lower said end relative to a surface upon which said tray assembly rests.
